(19) United States
(12) Patent Application Publication
(10) Pub. No.: US 2023/0213117 A1
(43) Pub. Date: Jul. 6, 2023

(54) Insert Molded Core Depressor

(71) Applicant: Fieldpiece Instruments, Inc., Orange, CA (US)

(72) Inventor: Henry J. Kuo, Orange, CA (US)

(73) Assignee: Fieldpiece Instruments, Inc., Orange, CA (US)

(21) Appl. No.: 18/079,771

(22) Filed: Dec. 12, 2022

Related U.S. Application Data
(60) Provisional application No. 63/296,064, filed on Jan. 3, 2022.

(51) Int. Cl. F16K 47/08; F25B 45/00; F25B 41/20

(52) U.S. Cl. CPC F16K 47/08; F25B 45/00; F25B 41/20; F25B 2345/006

(57) ABSTRACT

The devices and methods described below provide for an insert molded core depressor in which the core depressor blade is molded into a neoprene gasket. This configuration ensures that the core depressor blade does not separate from the neoprene gasket and provides a significantly improved channel for the conduction of refrigerant through the core depressor and valve.

### FIELD OF THE INVENTIONS

The inventions described below relate to the field of heating, ventilation and air conditioning equipment.

### BACKGROUND OF THE INVENTIONS

Conventional heating, ventilation, air conditioning and refrigeration (HVACR) Schrader® valves are a connector to allow refrigerant to be introduced into an HVACR system or removed from an HVACR system. (Schrader® is a registered trademark of Sensata Technologies, Inc.) The Schrader® valve core is centrally located in the valve and spring-biased to a closed position preventing refrigerant from escaping. When a mating connector is attached, a centrally located “core depressor” pushes the top pin of the core, compresses the biasing spring and causes the valve to open, allowing refrigerant flow.

Some conventional core depressors are hollow (to allow refrigerant flow) and have threaded sides to engage the inside surface of a gasket. Another type of conventional core depressors have a flat blade that threads into the inside surface of a gasket, allowing refrigerant flow through the gasket on either side of the core depressor blade. These two-piece designs limit the cross-section of the valve that is available to conduct refrigerant. Additionally, conventional core depressors and their gaskets have a limited life as a result of their constant use by HVACR technicians. When they are replaced the core depressor often separates from the gasket requiring a busy technician to use some metal tool to remove the troublesome gasket from the narrow mating connector. The use of metal tools in the mating connector often scratch and gouge the precision surfaces of the mating connector leading to leaks. Additionally, the two-piece design sometimes results in axial misalignment between the core depressor and the gasket which may cause opening of valve before seal is achieved (leakage), or valve failure to open.

### SUMMARY

The devices and methods described below provide for an insert molded core depressor in which the core depressor blade is molded into a neoprene gasket. This configuration ensures that the core depressor blade does not separate from the neoprene gasket and provides a significantly improved channel for the conduction of refrigerant through the core depressor and valve.

### BRIEF DESCRIPTION OF THE DRAWINGS

FIG. 1A is a top view of a prior art two-piece core depressor.

FIG. 1B is a side view of the prior art two-piece core depressor of FIG. 1A.

FIG. 1C is an exploded side view of the prior art two-piece core depressor of FIG. 1A.

FIG. 1D is a perspective view of a mating connector and the prior art two-piece core depressor of FIG. 1A.

FIG. 1E is a top view the prior art two-piece core depressor of FIG. 1A highlighting the comparatively small flow channel compared to that of the insert molded core depressor of FIG. 8.

FIG. 1F is a side view of the flow channel of the prior art two-piece core depressor of FIG. 1A.

FIG. 1G is a cross section view of the flow channel of FIG. 1F taken along A-A.

FIG. 2 is a top view of an insert molded core depressor.

FIG. 3 is a side view of the insert molded core depressor of FIG. 2.

FIG. 4 is a bottom view of the insert molded core depressor of FIG. 2.

FIG. 5 is a side view of the insert molded core depressor of FIG. 2 illustrating the core depressor blade.

FIG. 6 is a perspective view of a mating connector and the insert molded core depressor of FIG. 2.

FIG. 7 is an exploded perspective view of a mating connector, the insert molded core depressor of FIG. 2 with a Schrader® valve and Schrader® valve body.

FIG. 8 is a top view of the insert molded core depressor of FIG. 2 illustrating the thickness of the core depressor blade and highlighting the comparatively large flow channel compared to the prior art core depressor of FIG. 1E.

FIG. 9 is a side view of the flow channel of the insert molded core depressor of FIG. 8.

FIG. 10 is a cross section view of the flow channel of FIG. 9 taken along B-B.

### DETAILED DESCRIPTION OF THE INVENTIONS

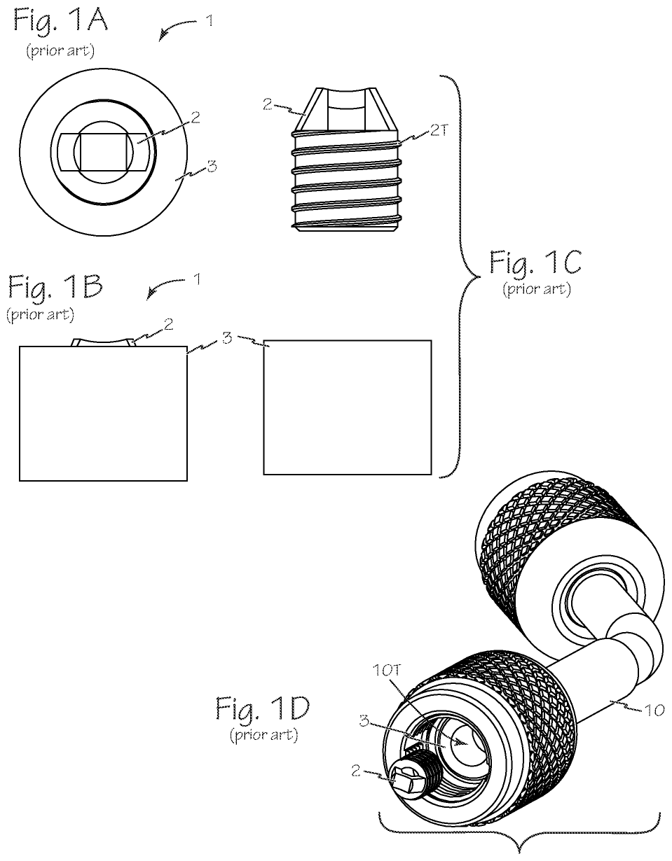

FIGS. 1A, 1B, 1C and 1D Illustrate a prior-art two-piece core depressor 1. The core depressor element 2 engages gasket 3 using the threads 2T. In use, prior-art core depressor 1 is inserted into the throat 10T of fitting adapter 10 and the core depressor element 2 engages the core pin of a Schrader® valve and forces the valve open against the biasing spring when the fitting adapter engages the Schrader® valve housing. Removal of a prior art core depressor involves removing the core depressor element which often separates from the gasket, and then reaching through the gasket with a pick, hook, pliers of other tool to engage the gasket and pull it from the adapter throat which often results in damage to the machined surfaces of the fitting adapter throat.

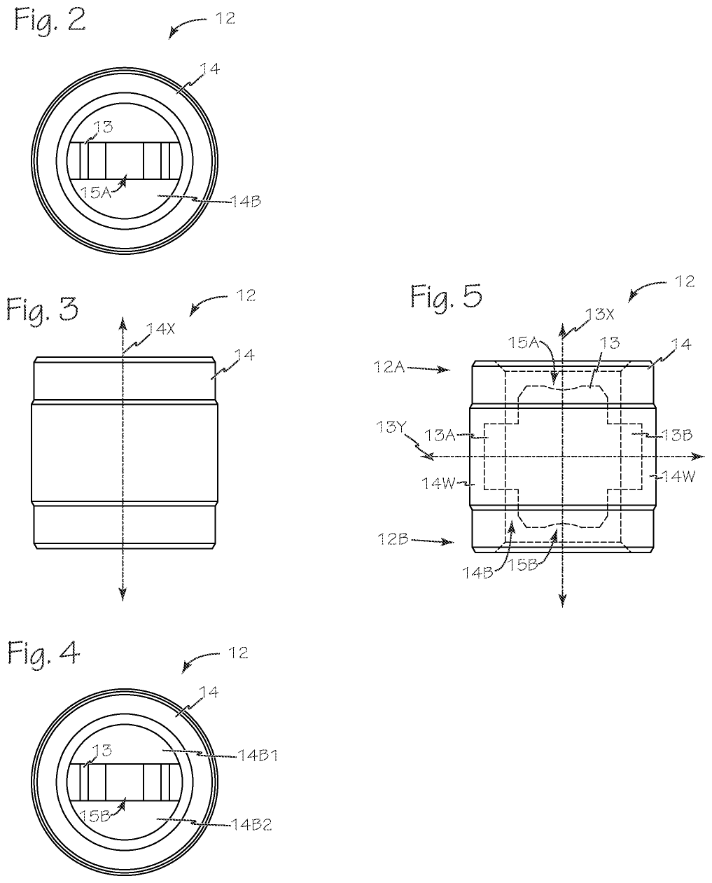

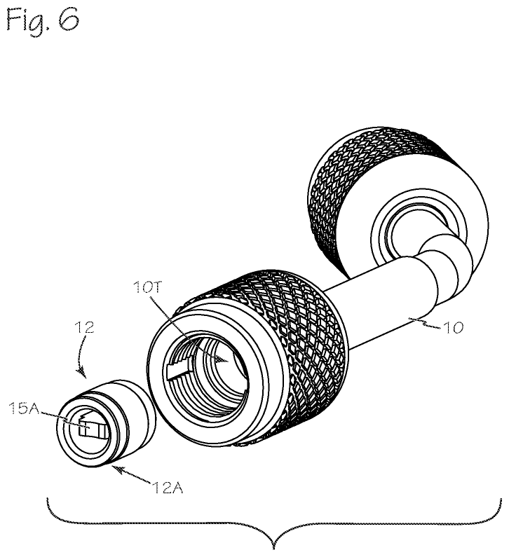

Insert molded core depressor 12 is illustrated in FIGS. 2, 3, 4, 5 and 8 and it includes core depressor blade 13 which is integrally molded, co-molded, into the gasket 14. This co-molded configuration results in a core depressor with a first engagement tip 15A extending from first end 12A and a second engagement tip 15B extending from second end 12B of the core depressor. Thus, core depressor is a reversable single part replacing two of the prior art devices. For the customer a single part is easier to stock or replace. The insert or co-molding of the core depressor blade 13 in the gasket 14 results in a reduced risk of axial misalignment between depressor blade 13 and the gasket 14 and makes installation and removal of the core depressor 12 simple.

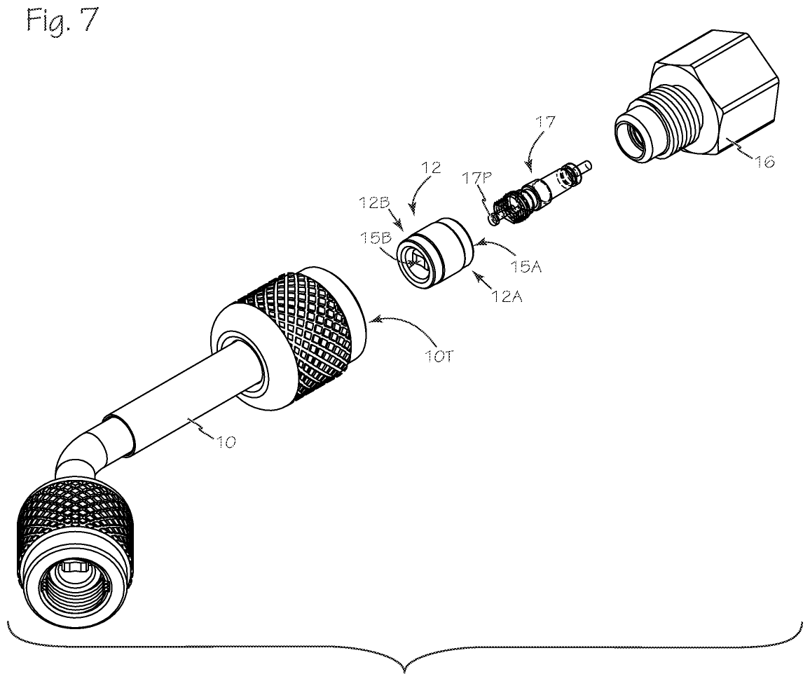

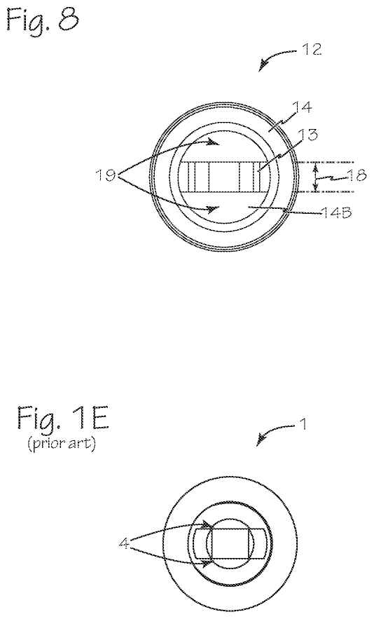

Gasket 14 is generally cylindrical with a central bore 14B. Central bore 14B has a longitudinal axis 14X. Core depressor blade 13 has identical first and second engagement tips 15A and 15B respectively located on longitudinal axis 13X. First engagement tip 15A and second engagement tip 15B are sized and dimensioned to engage the core pin 17P of a Schrader® valve 17 as illustrated in FIG. 7. Core depressor blade 13 has two wings 13A and 13B along transverse axis 13Y which is perpendicular to the longitudinal axis 13X. The core depressor blade wings 13A and 13B are insert molded or co-molded within the wall 14W of gasket 14 as shown in FIG. 5. The longitudinal axis 13X of the core depressor blade 13 is colinear with the longitudinal axis 14X of the gasket 14. This configuration results in the core depressor blade 13 splitting or bisecting flow channel 14B into first portion 14B1 and second portion 14B2 as shown in FIG. 4.

The insert or co-molded core depressor 12 is reversible which doubles the useful life of the core depressor and allows quick field repair of a leaking fitting when no spares are available.

In use, an insert or co-molded core depressor 12 illustrated in FIG. 7 is inserted into throat 10T of adapter 10 with either the first end 12A or the second end 12B facing out of the adapter throat. In this case, first end 12A is facing out. Core depressor 12 may be used with any suitable fitting or adapter. Adapter 10 engages Schrader® valve housing 16. As the adapter is brought into contact with the housing, engagement tip 15A engages core pin 17P compressing the biasing spring and opening Schrader® valve 17.

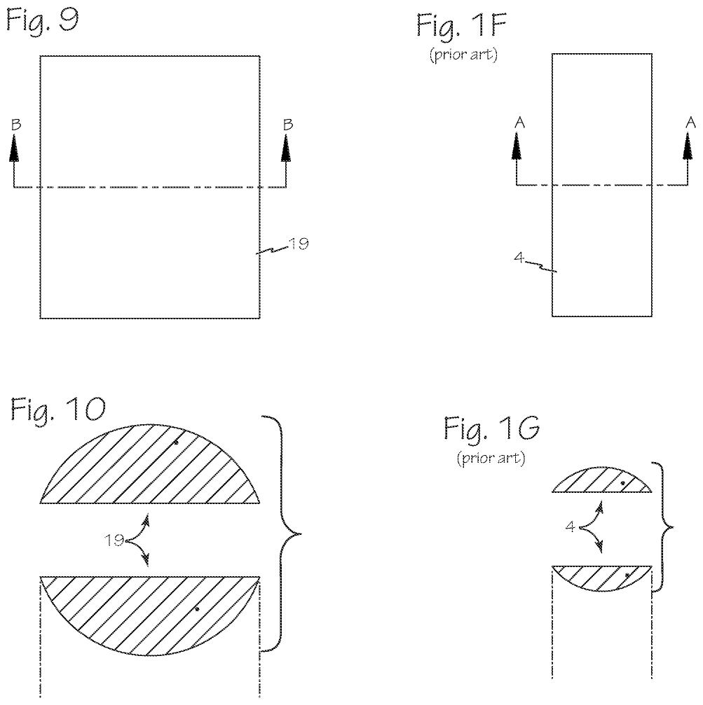

As illustrated in FIGS. 8, 9 and 10 the insert or co-molded core depressor 12 has core depressor blade 13 with a thickness 18 selected along with the diameter of gasket bore 14B to provide a significantly larger flow channel 19 past the core depressor blade and through the gasket than is available in the prior-art two-piece core depressor illustrated in FIGS. 1E, 1F and 1G. As illustrated, flow channel 19 of core depressor 12 is 85% larger than flow channel 4 of prior-art core depressor 1.

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

We claim:

1. A heating, ventilation, air conditioning and refrigeration core depressor insert comprising:
a core depressor blade with side wings and two engagement tips; and
a generally cylindrical gasket having a flow channel;
wherein the side wings are co-molded into the generally cylindrical gasket with the core depressor blade splitting the flow channel.

2. The heating, ventilation, air conditioning and refrigeration core depressor insert of claim 1 wherein the generally cylindrical gasket further comprises:
a longitudinal axis; and
the first and second engagement tips of the core depressor blade are located on a longitudinal axis of the core depressor blade.

3. The heating, ventilation, air conditioning and refrigeration core depressor insert of claim 2 wherein the longitudinal axis of the core depressor blade is colinear with the longitudinal axis of the generally cylindrical gasket.

4. A Schrader® valve core depressor comprising:
a generally cylindrical gasket having a generally cylindrical bore with a longitudinal axis;
a core depressor blade with a longitudinal axis and a first and second engagement tips located along the longitudinal axis, the core depressor blade also has a transverse axis perpendicular to the longitudinal axis and at least two side wings located along the transverse axis; and
wherein the side wings are co-molded into the generally cylindrical gasket with the core depressor blade splitting the bore.

5. A valve core depressor comprising:
a generally cylindrical gasket having a generally cylindrical bore with a longitudinal axis extending from a first end to a second end; and
a core depressor blade with a longitudinal axis colinear with the longitudinal axis of the gasket, the core depressor blade having and a first and second engagement tips located along the longitudinal axis of the core depressor blade, the core depressor blade also has a transverse axis perpendicular to the longitudinal axis of the core depressor blade and at least two side wings located along the transverse axis, wherein the side wings are co-molded into the generally cylindrical gasket with the core depressor blade splitting the bore.
